(19) United States
(12) Patent Application Publication
(10) Pub. No.: US 2018/0083312 A1
(43) Pub. Date: Mar. 22, 2018

(54) INTEGRATED ELECTRICAL FEEDTHROUGHS FOR WALLS OF BATTERY HOUSINGS

(71) Applicant: Apple Inc., Cupertino, CA (US)

(72) Inventors: Brian K. Shiu, Sunnyvale, CA (US); Christopher R. Pasma, Mountain View, CA (US); Haran Balaram, Sunnyvale, CA (US)

(21) Appl. No.: 15/711,273

(22) Filed: Sep. 21, 2017

Related U.S. Application Data
(60) Provisional application No. 62/398,216, filed on Sep. 22, 2016.

(51) Int. Cl. H01M 10/0525; H02G 3/02; H01M 2/02; H01M 2/06; H01M 2/08; H01M 2/30

(52) U.S. Cl. CPC H01M 10/0525; H02G 3/02; H01M 2/0262; H01M 2/305; H01M 2/065; H01M 2/08; H01M 2/0285

(57) ABSTRACT

Electrical feedthroughs are presented that are integrated within a wall of a battery housing. In some embodiments, an electrical feedthrough includes a battery housing defining an opening. The electrical feedthrough also includes a collar disposed around the opening and forming a single body with the wall. The electrical feedthrough also includes an electrically-conductive terminal disposed through the collar. The electrical feedthrough additionally includes an electrically-insulating material disposed between the collar and the electrically-conductive terminal and forming a seal therebetween. In some embodiments, the wall has a thickness equal to or less than 1 mm. In some embodiments, the collar protrudes into the battery housing. In other embodiments, the collar protrudes out of the battery housing. In some embodiments, a cross-sectional area of the electrically-conductive terminal is at least 40% of an area bounded by an outer perimeter of the collar. Batteries incorporating the electrical feedthroughs are also presented.

### CROSS-REFERENCE TO RELATED APPLICATIONS

The disclosure claims the benefit under 35 U.S.C. §119(e) of U.S. Provisional Patent Application No. 62/398,216, entitled “INTEGRATED ELECTRICAL FEEDTHROUGHS FOR WALLS OF BATTERY HOUSINGS” filed on Sep. 22, 2016, which is incorporated herein by reference in its entirety.

### FIELD

This disclosure relates generally to electrical feedthroughs, and more particularly, to integrated electrical feedthroughs for walls of battery housings.

### BACKGROUND

An electrical feedthrough may be employed to make an electrical connection through a battery housing or “can”. In some variations, a welding process may be used to physically couple the electrical feedthrough to a wall of the battery housing. The welding process may involve welding a flange of the electrical feedthrough to the wall. However, the flange occupies space on the wall, which interferes with reducing a size of the battery housing for portable and mobile electrics. The flange may also occupy space that would otherwise be available for a larger electrical feedthrough. In some applications, larger electrical feedthroughs are desirable due to their capability to carry higher electrical currents.

Heating and cooling of the electrical feedthrough during welding can generate thermally-induced stresses. These thermally-induced stresses can cause cracks within the electrical feedthrough, especially within an electrically-insulating material of the electrical feedthrough. It will be appreciated that electrically-insulating materials for electrical feedthroughs are often ceramic materials or glass materials. Such materials tend to relieve high stresses through cracking, unlike metal materials which can plastically deform or stretch. Cracks within the electrically-insulating material are undesirable as a sealing capability of the electrical feedthrough is reduced. An electrical insulating capability of the electrical feedthrough may also be lost. The battery industry seeks electrical feedthroughs that can better support battery housings, especially battery housings for portable and mobile electronics.

### SUMMARY

The following disclosure relates to electrical feedthroughs integrated within a wall of a battery housing. In some embodiments, an electrical feed through includes a battery housing having a wall with an opening disposed therein. The electrical feedthrough also includes a collar disposed around the opening and forming a single body with the wall. The electrical feedthrough also includes an electrically-conductive terminal disposed through the collar. The electrical feedthrough additionally includes an electrically-insulating material disposed between the collar and the electrically-conductive terminal and forming a seal therebetween. In some embodiments, the wall has a thickness equal to or less than 1 mm. In some embodiments, the collar protrudes into the battery housing. In other embodiments, the collar protrudes out of the battery housing. In some embodiments, a cross-sectional area of the electrically-conductive terminal is at least 40% of an area bounded by an outer perimeter of the collar.

The following disclosure also relates to batteries that include such electrical feedthroughs. In some embodiments, a battery includes an electrode assembly that includes a cathode electrode, an anode electrode, and a separator disposed therebetween. The battery also includes a battery housing containing the electrode assembly and an electrolyte. The battery housing includes a wall with an opening disposed therein. A collar is disposed around the opening and forming a single body with the wall. The battery housing also includes an electrically-conductive terminal disposed through the collar and electrically-coupled to the cathode electrode or the anode electrode of the electrode assembly. An electrically-insulating material disposed between the collar and the electrically-conductive terminal and forming a seal therebetween. In some embodiments, the electrode assembly includes a conductive tab coupled to the cathode electrode or the anode electrode. In these embodiments, the electrically-conductive terminal is coupled to the conductive tab. In some embodiments, a cross-sectional area of the electrically-conductive terminal is at least 40% of an area bounded by an outer perimeter of the collar. In further embodiments, the electrode assembly has a volumetric energy density greater than 300 W·h/l.

In another example, a battery comprises an electrode assembly comprising a first electrode, a second electrode, and a separator disposed therebetween. The first or second electrode may be an anode and a cathode or vice versa. The battery includes a battery housing containing the electrode assembly and an electrolyte. The battery housing includes a wall integrally defining a flange around an aperture. The flange may extend inwardly into the housing or outwardly. The flange, which in one example is a collar, is integrally formed in the wall and may or may not define a continuous annular surface around the aperture. A terminal extends through the aperture and is coupled with the first electrode. And, a sealing material, such as glass and other materials discussed herein, is between the terminal and the flange, which forms a seal between the same.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A is a perspective view, in cross-section, of a portion of a battery housing having an electrical feedthrough;

FIG. 1B is a perspective view, in cross-section, of the portion of the battery housing of FIG. 1A, but with a continuous sequence of spot-welds formed along a portion of an outer circumference of an electrical feedthrough;

FIG. 2A is a side view, in cross-section, of an electrical feedthrough integrated within a wall of a battery housing, according to an illustrative embodiment;

FIG. 2B is a side view, in cross-section, of the electrical feedthrough of FIG. 2A, but with a collar protruding out of the battery housing, according to an illustrative embodiment;

FIG. 2C is a side view, in cross-section, of the electrical feedthrough of FIG. 2A, but with a flange joint between different portions of a battery housing; and

FIG. 3 is a side-by-side overlay of a second cross-sectional side view disposed over a first cross-sectional side view, but in which the first cross-sectional side view includes a first electrical feedthrough having an weldable eyelet with a flange and the second cross-sectional side view includes a second electrical feedthrough with a collar, according to an illustrative embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

To store and supply electrical energy, battery cells commonly employ an electrode assembly, which includes a separator interposed between a cathode electrode and an anode electrode. The separator serves, in part, to regulate electrochemical reactions between the cathode electrode and the anode electrode. Because such electrochemical reactions can be negatively influenced by ambient hazards (e.g., moisture, dust, sharp objects, impacts, etc.), battery cells often enclose the electrode assembly in a battery housing. The battery housing, sometimes referred to as a “can,” isolates and protects the electrode assembly from its ambient environment.

When enclosed, the electrode assembly relies on an electrical path through the battery housing to receive and deliver electrical energy. This electrical path is often provided by an electrical feedthrough. The electrical feedthrough is disposed in a wall of the battery housing and is electrically-coupled to either the cathode electrode or the anode electrode. A common configuration includes one electrical feedthrough for each of the cathode electrode and the anode electrode. However, if the battery housing is electrically-conductive, the battery housing may serve as an electrical feedthrough, typically for the anode electrode.

Battery housings are being increasingly designed with small side walls, which reflect thinning allocations of space within target applications (e.g., mobile devices, portable electronics, etc.). These small side walls support coupling between the electrode assembly (i.e., the cathode electrode, the anode electrode, etc.) and one or more electrical feedthroughs. However, conventional electrical feedthroughs are ill-suited for small side walls. Conventional electrical feedthroughs commonly employ a flange to facilitate welding to a wall. Due to space constraints, the flange restricts the size of an electrically-conductive terminal disposed through a conventional electrical feedthrough. This restriction reduces a capacity of the electrically-conductive terminal (and hence the conventional electrical feedthrough) to carry electrical current, especially for small walls. In contrast, electrode assemblies continue to demonstrate higher electrochemical power densities, which in turn, increase a magnitude of electrical currents supplied to and delivered from such electrode assemblies.

Conventional electrical feedthroughs also poorly tolerate welding processes when scaled to accommodate small walls. When scaled, the flange offers a reduced volume of material to absorb and distribute heat during welding, thereby allowing high temperature gradients to develop. These high temperature gradients induce high stress gradients. High stress gradients can cause sealing materials in conventional electrical feedthroughs to crack or fracture, negating the possibility of a hermetically-sealed battery housing.

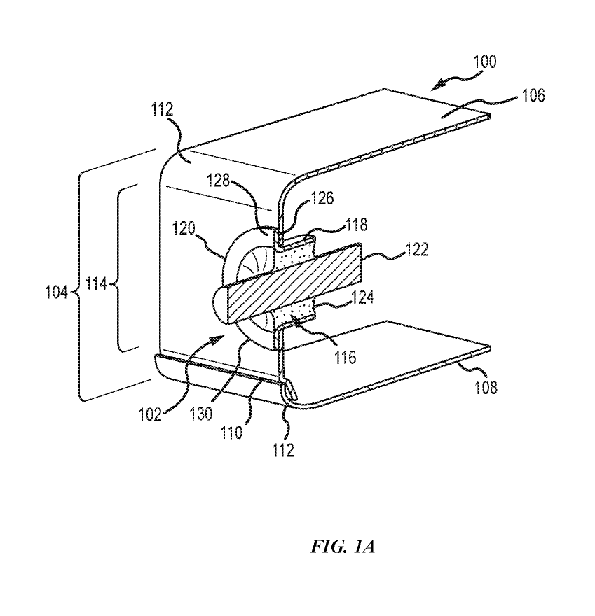

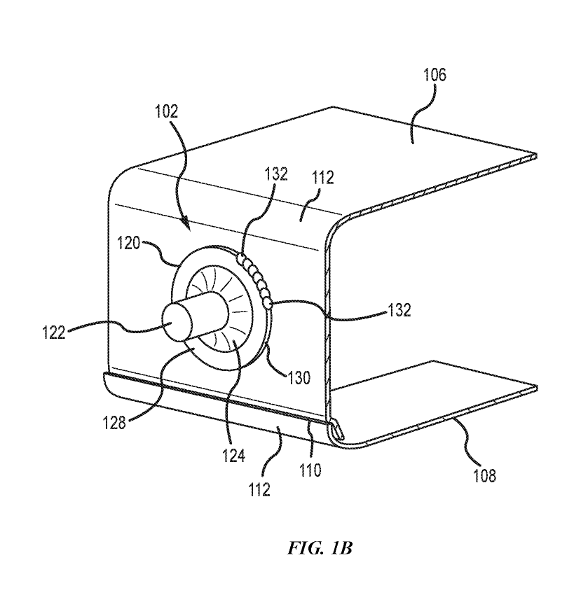

Now referring to FIG. 1A, a perspective view is presented, in cross-section, of a portion of a battery housing 100 having an electrical feedthrough 102. The electrical feedthrough 102 is disposed through a side wall 104 of the battery housing 100. The battery housing 100 includes a first wall 106 and a second wall 108 that meet along a seam 110 within the side wall 104. The seam 110 may be crimped, welded, brazed, etc. to form a hermetically-sealed joint. The battery housing 100 also includes rounded corners 112 formed into the first wall 106 and the second wall 108. The rounded corners 112 straddle a portion of the side wall 104 defining a flat surface 114. The flat surface 114 includes an opening 116 through which the electrical feedthrough 102 is disposed.

The electrical feedthrough 102 includes a tubular conduit 118 that terminates at one end in a flange 120. The tubular conduit 118 and the flange 120, as a single body, may be referred to as an “eyelet.” The tubular conduit 118 has an outer diameter slightly less than dimensions of the opening 116 (i.e., to allow a sliding fit). The tubular conduit 118 and the flange 120 may be formed of a metal body (e.g., a stainless steel body). The electrical feedthrough 102 also includes a terminal 122 disposed through the tubular conduit 118. The terminal 122 is formed of an electrically-conductive material, such as aluminum, and may extend past both ends of the tubular conduit 118, as shown in FIG. 1A. A sealing material 124 is interposed between the terminal 122 and the tubular conduit 118 (i.e., couples the terminal 122 to the tubular conduit 118). The sealing material 124 is formed of an insulating material, such as a glass material. Hence, the sealing material 124 is operable to electrically insulate the terminal 122 from the tubular conduit 118 and establish a first hermetic seal therebetween.

The flange 120 has an interior-facing surface 126 disposed against the flat surface 114 and an exterior-facing surface 128 oriented away from the side wall 104. The flange 120 is dimensioned such that overlap between the interior-facing surface 126 and the flat surface 114 is sufficient to allow a second hermetic seal to form during welding. Moreover, an outer circumference 130 of the flange 120 and a position of the opening 116 are such that the interior-facing surface 126 maintains contact only with the flat surface 114. The flange 120 does not contact the seam 110 or extend past a rounded corner 112, either of which, would impede or prevent the second hermetic seal from forming.

FIG. 1B presents a perspective view, in cross-section, of the portion of the battery housing 100 of FIG. 1A, but with a continuous sequence of spot-welds 132 formed along a portion of the outer circumference 130. During manufacture, the electrical feedthrough 102 is disposed through the opening 116 and heat from an energy source (e.g., a torch, a laser, an ultrasonic tip, etc.) is applied to a point along the outer circumference 130. Such heat melts a portion of the flange 120 (e.g., a spot on the flange 120) and involves the interior-facing surface 126 and an adjacent portion of the flat surface 114. Upon cooling, a metallurgical bond forms between the flange 120 and the flat surface 114. The energy source is then displaced clockwise (or counterclockwise) along the outer circumference 130 to establish a continuous sequence of spot-welds. This continuous sequence, when completed around the outer circumference 130, hermetically seals the electrical feedthrough 102 to the battery housing 100.

It will be appreciated that features of the side wall 104 (e.g., the seam 110, the rounded corner 112, etc.) limit space available for positioning the electrical feedthrough 102. As such, the space (height-wise) is notably less than an overall height of the side wall 104. To adapt to this limited space, the electrical feedthrough 102 can be scaled in dimensions. However, for side-wall heights less than 10 mm, the flange 120 may narrow (in annular width) to such an extent that, during welding, a high temperature gradient is established across the sealing material 124. This high temperature gradient can, in turn, induce a high stress gradient through the sealing material 124. High stress gradients are undesirable, and during certain welding processes, can cause the electrical feedthrough 102 to fail mechanically (e.g., crack).

Disclosed herein are electrical feedthroughs integrated into a wall of a battery housing. The electrical feedthroughs utilize a collar formed into the wall to replace a weldable eyelet, which is common to conventional feedthrough designs. By eliminating the weldable eyelet, and especially a flange of the weldable eyelet, the electrical feedthroughs can occupy less space on the wall and are suitable for small walls (i.e., less than 10 mm in height). Moreover, the electrical feedthroughs may be larger than otherwise possible. Larger feedthroughs can allow thicker-gauged terminals to be disposed through the wall. Such feedthroughs can also allow easier soldering or welding of conductive tabs from an electrode assembly to terminals of the electrical feedthroughs. Such feedthroughs may also support higher volumetric energy densities (i.e., greater than 300 W·h/l) for electrode assemblies disposed within the battery housing.

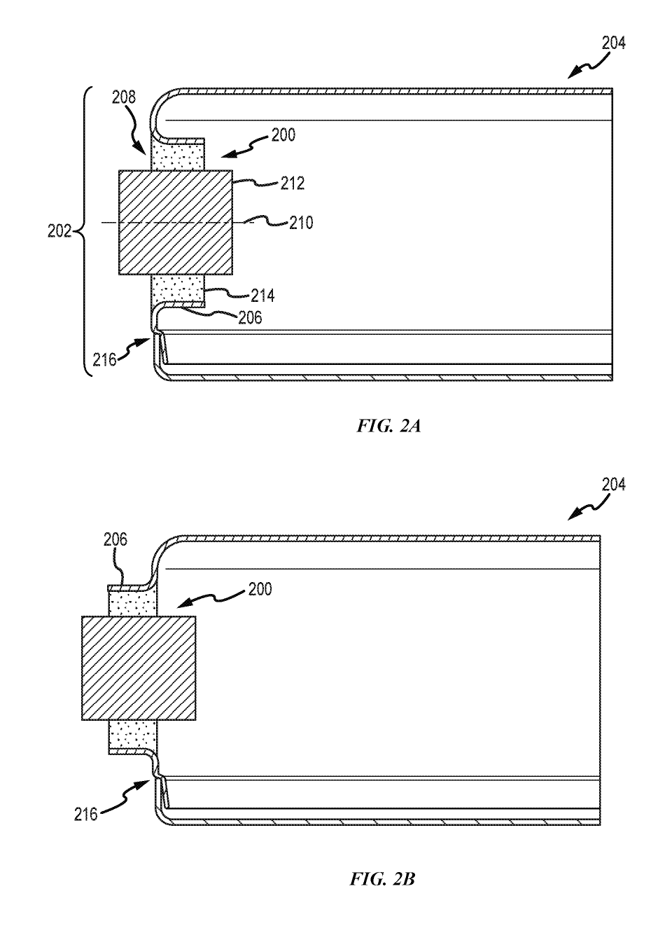

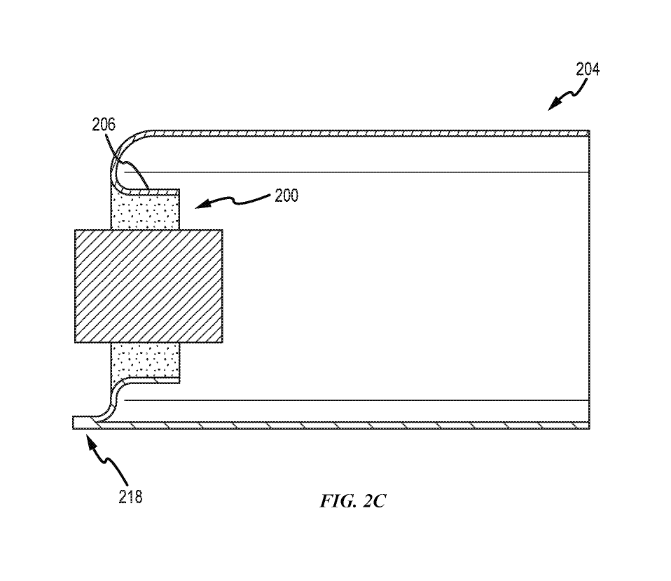

The electrical feedthroughs also reduce the component and manufacturing costs of a battery cell. Because the collar replaces the weldable eyelet, one less component is required for assembly of the battery cell. Moreover, the collar can be formed concurrently with the wall of the battery housing, i.e., without additional manufacturing steps. Unlike with the weldable eyelet, welding processes are not needed to attach the collar to the wall. Furthermore, sealing materials can be processed within the collar at temperatures optimal for their melting, softening, curing, and so forth. As such, cracking risks associated with thermally-induced stresses from welding are by-passed entirely. Illustrative embodiments of the electrical feedthroughs and their corresponding features are described below in relation to FIGS. 2A-2C.

Now referring to FIG. 2A, a side view is presented in cross-section of an electrical feedthrough 200 integrated within a wall 202 of a battery housing 204, according to an illustrative embodiment. The wall 202 may have a thickness equal to or less than 1 mm. The electrical feedthrough 200 includes the wall 202, which has an opening 208 disposed therein. A collar 206 is disposed around the opening 208 and forms a single body with the wall 202. The opening 208 may have any type shape capable of defining a perimeter for the collar 206 (e.g., circular, elliptical, hexagonal, etc.). In FIG. 2A, the collar 206 is depicted as extending along an axis 210 that is perpendicular to the wall 202. However, this depiction is not intended as limiting. Other directions are possible for the axis (e.g., non-perpendicular). Moreover, the collar 206 may alter in cross-section shape along the axis 210. For example, and without limitation, the collar 206 may taper when extending away from the wall 202. In another non-limiting example, the collar 206 may flare outwards upon extending away from the wall 202. In some embodiments, the thickness of the wall 202 includes a protrusion length of the collar 206 from the wall 202. The protrusion length may be measured along a distance perpendicular to the wall 202.

The electrical feedthrough 200 also includes an electrically-conductive terminal 212 disposed through the collar 206 (or the opening 208). The electrically-conductive terminal 212 may be centered within the opening 208 and may extend past one or both ends of the collar 206. In FIG. 2A, the electrical-conductive terminal 212 is depicted as centered and extending past both ends of the collar 206. However, this depiction is not intended as limiting. The electrically-conductive terminal 212 may have any type of cross-section (e.g., circular, square, elliptical, hexagonal, etc.). Moreover, the electrically-conductive terminal 212 may be formed of any material having an electrical conductivity greater than 10³ S/m. In some embodiments, the electrically-conductive terminal 212 is formed of metal. Non-limiting examples of the metal include copper, silver, gold, platinum, aluminum, titanium, tungsten, molybdenum, and iron. Other metals are possible, including alloys thereof (e.g., steel, stainless steel, copper alloys, aluminum alloys, titanium alloys, etc.).

The electrical feedthrough 200 additionally includes an electrically-insulating material 214 disposed between the collar 206 and the electrically-conductive terminal 212. The electrically-insulating material 214 couples the electrically-conductive terminal 212 to the collar 206 and forms a seal therebetween (i.e., an annular seal). The electrically-insulating material 214 may be any material having an electrical resistivity greater than 10⁸ Ω-cm (e.g., a ceramic material, a glass material, etc.). The electrically-insulating material 214 may also have a dielectric strength greater than 10 kV/mm. Non-limiting examples of the electrically-insulating material include glass materials, ceramic materials, glass-ceramic materials, epoxy materials, glass-filled epoxy materials, and ceramic-filled epoxy materials. Other electrically-insulating materials are possible. In some embodiments, the electrically-insulating material 214 is in a state of compression after forming the seal between the electrically-conductive terminal 212 and the collar 206.

In some embodiments, such as shown in FIG. 2A, the collar 206 protrudes into the battery housing 204. However, in other embodiments, the collar 206 protrudes out of the battery housing 204. FIG. 2B presents a side view, in cross-section, of the electrical feedthrough 200 of FIG. 2A, but with the collar 206 protruding out of the battery housing 204, according to an illustrative embodiment. For clarity, some features of FIG. 2A are not labeled in FIG. 2B. FIGS. 2A & 2B depict the battery housing 204 as utilizing a joggle lap joint 216 between different portions of the battery housing 204 (i.e., form a seam). However, this depiction is not intended as limiting. Other joints are possible for the battery housing 204. FIG. 2C presents a side view, in cross-section, of the electrical feedthrough 200 of FIG. 2A, but with a flange joint 218 between different portions of the battery housing 204. For clarity, some features of FIG. 2A are not labeled in FIG. 2C.

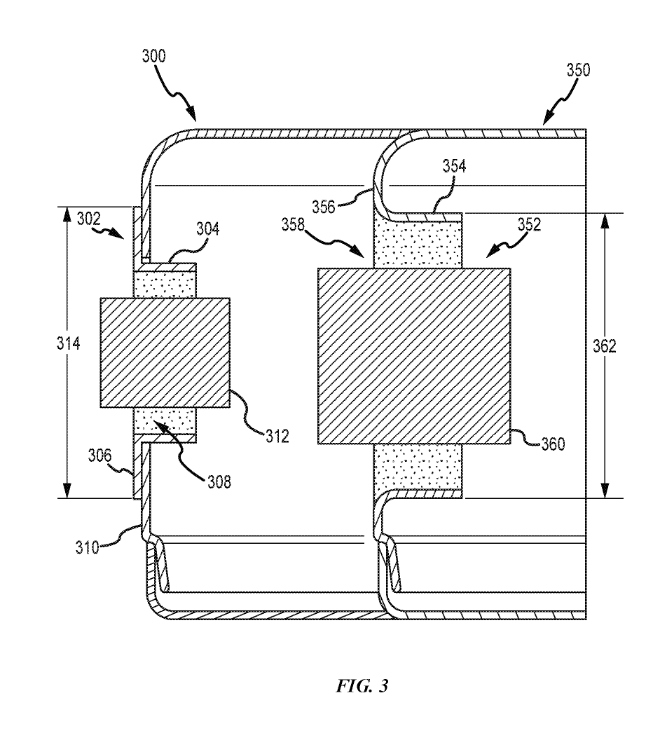

It will be appreciated that the collar 206 allows thicker-gauged electrically-conductive terminals than those possible with a weldable eyelet. The collar 206, being an integral part of the wall 202, does not require a flange, unlike the weldable eyelet. Thus, the collar 206 allows the opening 208 to have a larger diameter, which in turn, allows thicker-gauged electrically-conductive terminals. FIG. 3 presents a side-by-side overlay of a second cross-sectional side view 350 disposed over a first cross-sectional side view 350, according to an illustrative embodiment. The first cross-sectional side view 300 includes a first electrical feedthrough 302 having an weldable eyelet 304 with a flange 306. The weldable eyelet 304 is disposed through a first opening 308 in a first wall 310 and includes a first electrically-conductive terminal 312 disposed therethrough. The second cross-sectional side view 350 includes a second electrical feedthrough 352 having a collar 354. The collar 354 is formed into a second wall 356 around a second opening 358 and includes a second electrically-conductive terminal 360 disposed therethrough. An outer diameter of the collar 354 (see dimension 362) is approximately equal to an outer diameter of the flange 306 (see dimension 314). However, the second electrically-conductive terminal 360 is notably larger (i.e., thicker in gauge) than the first electrically-conductive terminal 312. A comparison of the first cross-sectional side view 300 and the second cross-sectional side view 350 reveals that the flange 306, due to space for weldability, reduces space available for the first opening 308. This reduction is not found with the collar 206, which allows a larger diameter for the opening 358. Hence, a thicker gauge can be used for the second electrically-conductive terminal 369.

Thicker gauges for electrically-conductive terminals decrease a resistance experienced by electrical currents passing therethrough, which in turn, reduce undesirable losses of electrical energy via resistive heating. Other benefits may be possible. For example, and without limitation, increasing a radius of an electrically-conductive terminal increases its cross-sectional area exponentially by a factor of two (i.e., πr²). This increase in cross-sectional area exponentially reduces a resistance of the electrically-conductive terminal by a factor of two. The electrical feedthroughs 200, 352 described in relation to FIGS. 2A-2C & 3 can utilize thicker-gauge electrically-conductive terminals, thereby supporting higher current loads to and from electrode assemblies within a battery housing. It will be appreciated that these thicker gauge electrically-conductive terminals can be used in conjunction with electrode assemblies having high volumetric energy densities (i.e., greater than 300 W·h/l).

In some embodiments, a cross-sectional area of the electrically-conductive terminal 212 is a percentage of an area bounded by an outer perimeter of the collar 206, which may represent an outer perimeter of the electrical feedthrough 200. The percentage may be selected by those skilled in the art to allow the electrically-conductive terminals 212 to have increased current-carrying capacity. The percentage may be any value between 10-90%. In some instances, the percentage is a range defined by a lower limit and an upper limit. Non-limiting examples of the lower limit include equal to or greater than 10%, equal to or greater than 20%, equal to or greater than 30%, equal to or greater than 40%, equal to or greater than 50%, equal to or greater than 60%, equal to or greater than 70%, and equal to or greater than 80%. Non-limiting examples of the upper limit include equal to or less than 90%, equal to or less than 80%, equal to or less than 70%, equal to or less than 60%, equal to or less than 50%, equal to or less than 40%, equal to or less than 30%, and equal to or less than 20%. It will be appreciated that the lower limit and the upper limit may be combined in any variation as above to define the range. For example, and without limitation, the cross-sectional area of the electrically-conductive terminal 212 may range from 40% to 70% of the cross-sectional area of the electrical feedthrough 200.

In further embodiments, the electrically-conductive terminal 212 is electrically-coupled to an electrode assembly having a volumetric energy density greater than 300 W·h/l. In some embodiments, the electrically-conductive terminal 212 is electrically-coupled to an electrode assembly having a volumetric energy density greater than 350 W·h/l. In some embodiments, the electrically-conductive terminal 212 is electrically-coupled to an electrode assembly having a volumetric energy density greater than 400 W·h/l. In some embodiments, the electrically-conductive terminal 212 is electrically-coupled to an electrode assembly having a volumetric energy density greater than 450 W·h/l. In some embodiments, the electrically-conductive terminal 212 is electrically-coupled to an electrode assembly having a volumetric energy density greater than 500 W·h/l. In some embodiments, the electrically-conductive terminal 212 is electrically-coupled to an electrode assembly having a volumetric energy density greater than 550 W·h/l. In the aforementioned embodiments, the electrically-conductive terminal 212 may be coupled to a conductive tab of the electrode assembly. Such coupling may involve a weld joint or a solder joint.

In some embodiments, the wall 202 has a thickness equal to or less than 1 mm. In some embodiments, the wall 202 has a thickness equal to or less than 0.9 mm. In some embodiments, the wall 202 has a thickness equal to or less than 0.8 mm. In some embodiments, the wall 202 has a thickness equal to or less than 0.7 mm. In some embodiments, the wall 202 has a thickness equal to or less than 0.6 mm. In some embodiments, the wall 202 has a thickness equal to or less than 0.5 mm. In some embodiments, the wall 202 has a thickness equal to or less than 0.4 mm. In some embodiments, the wall 202 has a thickness equal to or less than 0.3 mm. In some embodiments, the aforementioned thicknesses include a protrusion length of the collar 206 from the wall 202.

In some embodiments, the wall 202 has a thickness equal to or greater than 0.2 mm. In some embodiments, the wall 202 has a thickness equal to or greater than 0.3 mm. In some embodiments, the wall 202 has a thickness equal to or greater than 0.4 mm. In some embodiments, the wall 202 has a thickness equal to or greater than 0.5 mm. In some embodiments, the wall 202 has a thickness equal to or greater than 0.6 mm. In some embodiments, the wall 202 has a thickness equal to or greater than 0.7 mm. In some embodiments, the wall 202 has a thickness equal to or greater than 0.8 mm. In some embodiments, the wall 202 has a thickness equal to or greater than 0.9 mm. In some embodiments, the aforementioned thicknesses include a protrusion length of the collar 206 from the wall 202.

It will be understood that aforementioned upper and lower limits of the thickness may be combined in any variation as above to define a range. For example, and without limitation, the wall 202 may have a thickness equal to or greater than 0.4 mm but equal to or less than 0.9 mm. In another non-limiting example, the wall 202 may have a thickness equal to or greater than 0.3 mm and equal to or less than 0.7 mm. Other ranges of thickness for the wall 202 are possible. In some embodiments, the range includes a protrusion length of the collar 206 from the wall 202.

The battery housings described herein may contain an electrode assembly and an electrolyte. The electrode assembly may include a cathode electrode, an anode electrode, and a separator disposed therebetween. In some embodiments, the electrode assembly includes a stack of layers. In the stack of layers, layers of cathode electrode alternate with layers of anode electrode. A separator layer is disposed between each pair of adjacent cathode and anode electrode layers. The stack of layers may be planar or wound into a spiral configuration (i.e., a “jelly roll”). Other types of configurations, however, are possible for the stack of layers.

In many embodiments, the electrically-conductive terminal of the battery housing is electrically-coupled to the cathode electrode or the anode electrode. A conductive tab may couple the electrically-conductive terminal to the cathode electrode or the anode electrode of the electrode assembly.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A battery housing, comprising:
a wall with an opening disposed therein;
a collar disposed around the opening and forming a single body with the wall;
an electrically-conductive terminal disposed through the collar; and
an electrically-insulating material disposed between the collar and the electrically-conductive terminal and forming a seal therebetween.

2. The battery housing of claim 1, wherein the wall has a thickness equal to or less than 1 mm.

3. The battery housing of claim 2, wherein the thickness of the wall is at least 0.3 mm but no greater than 0.7 mm.

4. The battery housing of claim 1, wherein the collar protrudes into the battery housing.

5. The battery housing of claim 1, wherein the collar protrudes out of the battery housing.

6. The battery housing of claim 1, wherein a cross-sectional area of the electrically-conductive terminal is at least 40% of an area bounded by an outer perimeter of the collar.

7. The battery housing of claim 6, wherein the cross-sectional area of the electrically-conductive terminal is at least 40% but no greater than 70% of the area bounded by the outer perimeter of the collar.

8. A battery, comprising:
an electrode assembly comprising a cathode electrode, an anode electrode, and a separator disposed therebetween; and
a battery housing containing the electrode assembly and an electrolyte, the battery housing comprising:
a wall with an opening disposed therein,
a collar disposed around the opening and forming a single body with the wall,
an electrically-conductive terminal disposed through the collar and electrically-coupled to the cathode electrode or the anode electrode of the electrode assembly, and
an electrically-insulating material disposed between the collar and the electrically-conductive terminal and forming a seal therebetween.

9. The battery of claim 8, wherein the wall has a thickness equal to or less than 1 mm.

10. The battery of claim 8, wherein a cross-sectional area of the electrically-conductive terminal is at least 40% of an area bounded by an outer perimeter of the collar.

11. The battery of claim 10, wherein the cross-sectional area of the electrically-conductive terminal is at least 40% but no greater than 70% of the area bounded by the outer perimeter of the collar.

12. The battery of claim 10, wherein the electrode assembly has a volumetric energy density greater than 300 W·h/l.

13. The battery of claim 10, wherein the volumetric energy density of the electrode assembly is greater than 400 W·h/l.

14. The battery of claim 8,
wherein the electrode assembly further comprises a conductive tab coupled to the cathode electrode or the anode electrode; and
wherein the electrically-conductive terminal is coupled to the conductive tab.

15. The battery of claim 8 wherein the electrically insulating material is glass.

16. A battery comprising:
an electrode assembly comprising a first electrode, a second electrode, and a separator disposed therebetween; and
a battery housing containing the electrode assembly and an electrolyte, the battery housing comprising:
a wall integrally defining a flange around an aperture;
a terminal extending through the aperture and coupled with the first electrode; and
a sealing material between the terminal and the flange.
